(19) United States
(12) Patent Application Publication
(10) Pub. No.: US 2019/0239458 A1
(43) Pub. Date: Aug. 8, 2019

(54) Planter Water, Oxygen And Fertilizer Measuring Cup And Soil Penetrating Tube Apparatus

(71) Applicant: Wow Product Sales, LLC, Fenton, MI (US)

(72) Inventor: David M. Allen, Fenton, MI (US)

(21) Appl. No.: 16/267,611

(22) Filed: Feb. 5, 2019

Related U.S. Application Data
(60) Provisional application No. 62/626,381, filed on Feb. 5, 2018.

(51) Int. Cl. A01G 27/00

(52) U.S. Cl. CPC A01G 27/006; A01G 27/008

(57) ABSTRACT

A planter water, oxygen and fertilizer measuring cup and soil penetrating tube apparatus is disclosed. The planter tube apparatus includes an upper reservoir and an angled lower dispensing tube. The upper reservoir includes a base and an upstanding wall, defining a volume, with a lower opening defined in at least one of the base and the upstanding wall in fluid communication with the volume. The angled lower dispensing tube extends from the upper reservoir. The angled lower dispensing tube is angled relative to the base of the upper reservoir. The angled lower dispensing tube has an outer surface and an inner channel, extending between a proximal end and a distal end, with a plurality of openings being positioned therebetween and extending through the outer surface and into the inner channel. A combination planter and planter tube apparatus is disclosed, as is a method of use.

### CROSS-REFERENCE TO RELATED APPLICATION

This application claims priority from U.S. Pat. App. Ser. No. 62/626,381 filed Feb. 5, 2018, entitled PLANTER WATER, OXYGEN AND FERTILIZER EASURING CUP AND SOIL PENETRATING TUBE APPARATUS, the entire specification of which is hereby incorporated by reference in its entirety.

### BACKGROUND OF THE DISCLOSURE

### 1. Field of the Disclosure

The disclosure relates in general to plant care, and more particularly, to a planter water, oxygen and fertilizer (i.e., beneficial agents, among others) measuring cup and soil penetrating tube apparatus.

### 2. Background Art

When foliage and blooms cover a planter and fill the same, watering and providing other nutrients may be difficult. This covering, together with compacted soil, make it difficult to adequately provide nutrients to the plant.

Some solutions include water bottles with large curved tubes that can be maneuvered. Problematically, it is difficult to apply water where necessary and difficult to often times penetrate the surface of the soil. Thus, many of the nutrients and the like end up in the water catch tray. Thus, improvements to the same are desired.

### SUMMARY OF THE DISCLOSURE

The disclosure is directed to a planter tube apparatus comprising an upper reservoir and an angled lower dispensing tube. The upper reservoir comprises a base and an upstanding wall, defining a volume, with a lower opening defined in at least one of the base and the upstanding wall in fluid communication with the volume. The angled lower dispensing tube extends from the upper reservoir. The angled lower dispensing tube is angled relative to the base of the upper reservoir. The angled lower dispensing tube has an outer surface and an inner channel, extending between a proximal end and a distal end, with a plurality of openings being positioned therebetween and extending through the outer surface and into the inner channel.

In some configurations, the base has an upper surface and a lower surface, with the angled lower dispensing tube being angled relative to a plane defined by the upper surface of the base at an angle of approximately between 105° and 165°. In some configurations, the angle is between 120° and 150°.

In some configurations, the base has an upper surface and a lower surface, and further includes an engaging tab extending from the lower surface, structurally configured to engage a planter about an upper rim therof.

In some configurations, the engaging tab extends generally perpendicularly from the lower surface of the base of the upper reservoir.

In some configurations, the angled lower dispensing tube further includes a tip defined at the distal end thereof which aids in the penetration of the angled lower dispensing tube into a soil.

In some configurations, the openings of the angled lower dispensing tube include a plurality of at least one of holes and slots, with the slots being substantially perpendicular to a central axis of the inner channel.

In some configurations, the angled lower dispensing tube further includes an outer portion and an inner portion, with the openings being disposed on the inner portion between the proximal and distal end of the angled lower dispensing tube.

In some configurations, a plurality of slots in a substantially parallel configuration is disposed proximate the distal end.

In some configurations, a plurality of holes is disposed between the plurality of slots and the proximal end of the angled lower dispensing tube.

In some configurations, the upstanding wall is substantially perpendicular to an upper surface of the base of the upper reservoir.

In some configurations, the upstanding wall has a cross-sectional configuration of a flower.

In some configurations, the inner channel has a plurality of longitudinal ribs that extend inwardly from a base surface of the inner channel toward a central axis thereof, with the plurality of longitudinal ribs defining a fertilizer spike receiving region.

In some configurations, the longitudinal inward ribs extend generally colinerly with the central axis of the inner channel.

In some configurations, the upper reservoir and the angled lower dispensing tube are integrally molded.

In some configurations, the lower opening of the upper reservoir is defined in a portion of each of the base and the upstanding wall.

In another configuration, the disclosure is directed to a combination planter and planter tube apparatus comprising a planter tube apparatus and a planter. The planter tube is described hereinabove, with the planter including a base with an upstand extending from the base. The upstand terminates in an upper rim, with the base and the upstand defining a central cavity structurally configured to receive a soil into which a plant may be planted.

In another aspect of the disclosure, the disclosure is directed to a method of using a planter tube apparatus comprising the steps of: providing a planter having a base and an upstand defining a central cavity; providing a planter tube apparatus including an upper reservoir with a base and an upstanding wall, cooperatively defining a volume with a lower opening in fluid communication with the volume, and, an angled lower dispensing tube extending from the upper reservoir, the angled lower dispensing tube having an outer surface and an inner channel in fluid communication with the lower opening of the upper reservoir, with a plurality of openings extending through the outer surface and into the inner channel; inserting the planter tube apparatus into the central cavity of the planter; providing soil into the central cavity of the planter, wherein at least a portion of the angled lower dispensing tube is in the soil; providing a plant, with at least a portion of the plant being within the soil; and providing a fluid into the upper reservoir, so that the fluid can proceed through the angled lower dispending tube and through the openings thereof into the soil.

In some such methods, the inner channel includes a plurality of longitudinal inward ribs, and the method further comprises the step of: inserting a fertilizer spike into the inner channel of the angled lower dispensing tube, wherein the fertilizer spike is captured by the longitudinal inward ribs. While this.

### BRIEF DESCRIPTION OF THE DRAWINGS

The disclosure will now be described with reference to the drawings wherein:

FIG. 1 of the drawings is a perspective view of a configuration of the planter tube apparatus in a planter, showing, an orientation thereof in position, with the soil and plant not present for pictorial clarity;

FIG. 2 of the drawings is a perspective view of a configuration of the planter tube apparatus shown in an operating configuration within a planter having soil and a plant planted in the soil that's in the planter;

FIG. 3 of the drawings is a perspective view of a configuration of the planter tube apparatus showing the upper reservoir and the angled lower dispensing tube thereof;

FIG. 4 of the drawings is a cross-sectional view of the planter tube apparatus; and

FIG. 5 of the drawings is a cross-sectional view of the planter tube apparatus of FIGS. 3 and 4, taken generally about lines 5-5 of FIG. 3, and showing a fertilizer spike positioned therein and supported by the longitudinal inward ribs;

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

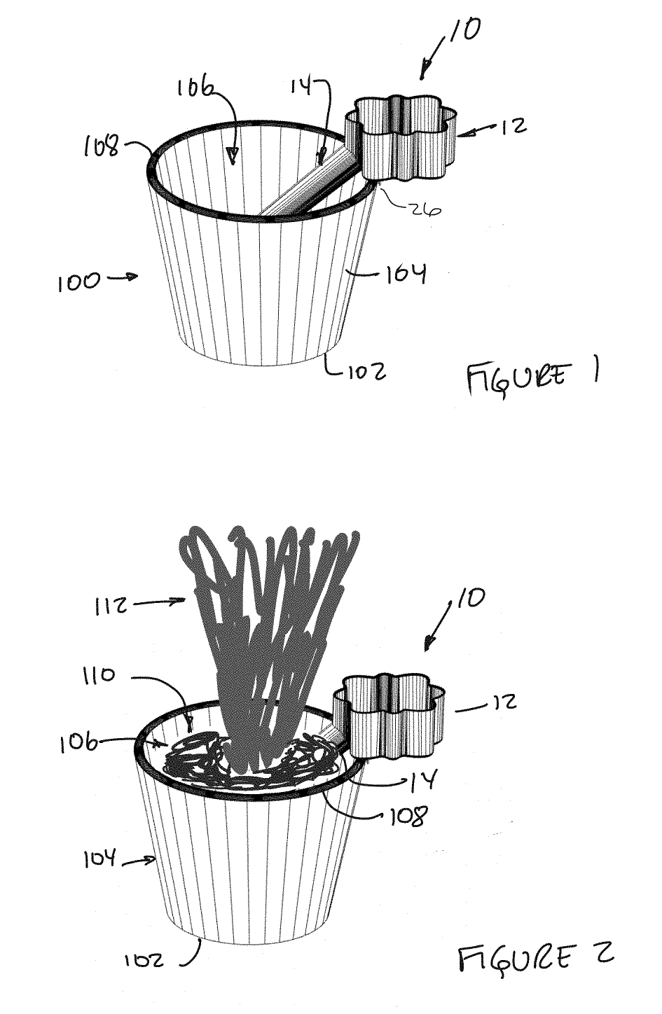

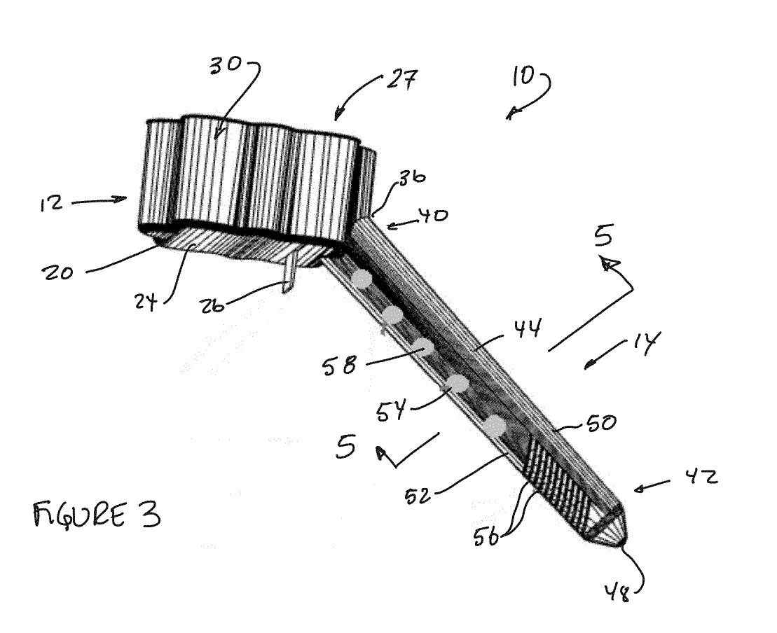

Referring now to the drawings, and in particular, FIG. 1, the planter water, oxygen and fertilizer measuring cup and soil penetrating tube apparatus is shown generally at 10 (hereinafter sometimes referred to as the planter tube apparatus 10). The planter tube apparatus is configured for use in a planter, such as planter 100 to deliver water, oxygen, fertilizer and the like to a plant within the planter. In the configuration shown, the planter 100 includes base 102, an upstand 104 (in the configuration shown comprises a frustoconical configuration) and defines a central cavity 106. The upstand extends from the base 112 and terminates at upper rim 108. Positioned within the planter 100 can be a soil mixture 110 and a plant may be planted within the soil 112.

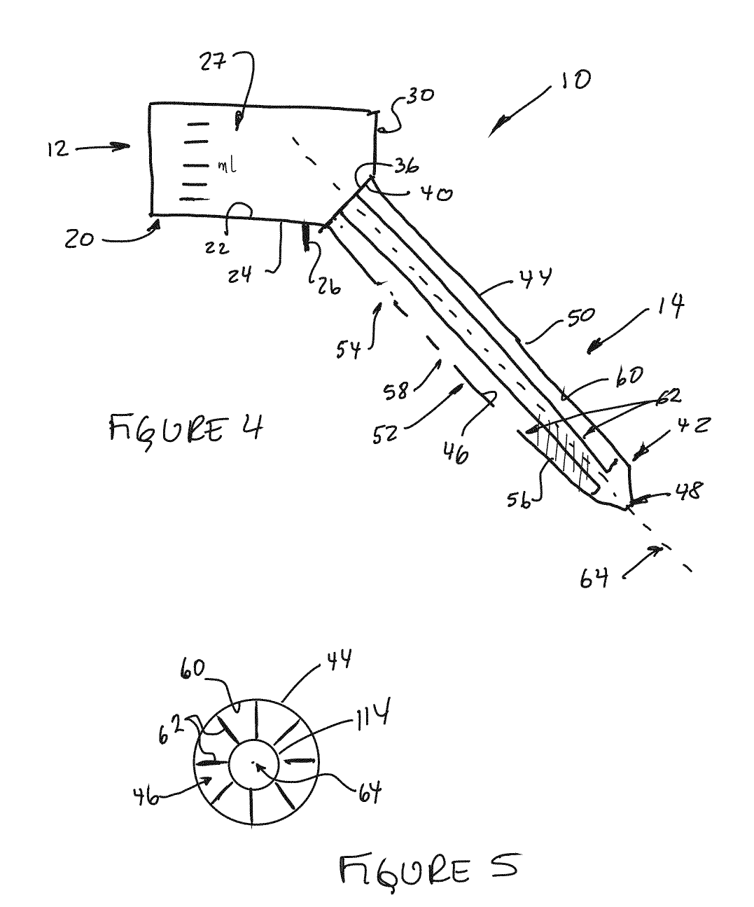

The planter tube apparatus 10 is shown in greater detail in FIGS. 3 through 5 as comprising upper reservoir 12 and angled lower dispensing tube 14. In some configurations the planter tube apparatus may be molded as a single integrally formed structure, whereas, in other configurations, multiple components are contemplated for forming such a structure. For example, the upper reservoir and the angled lower dispensing tube may comprise separate components that are joined together through a press fit, a fastener, or through adhesives.

The upper reservoir 12 includes base 20, upstanding wall 30 and lower opening 36. The base 20 includes upper surface 22 and lower surface 24 which define a generally planar configuration. An engaging tab (or tabs) 26 may extend outwardly from the lower surface 24. The engaging tab can be used to locate and fix the position of the planter tube apparatus relative to the planter, by abutting the engaging tab against the inner surface of the upstand 104. In other configurations, a pair of engaging tabs can extend from the lower surface in a spaced apart configuration to sandwich a portion of the upper rim of the upstand therebetween.

The upstanding wall 30 extends upwardly away from the upper surface 22 of the base 20. In the configuration shown, the upstanding wall 30 is generally perpendicular to the upper surface of the wall. The upstanding wall comprises a plurality of adjacent arcuate portions that define a flower-like cross-sectional configuration. Of course, other configurations of the wall are contemplated, and the device is not limited to any particular configuration of the upstanding wall. The upstanding wall 30 has a lower edge 32 that meets the upper surface 22 of the base, and upper edge 34 spaced apart from the lower edge which defines the termination of the upstanding wall 30. In the configuration shown, the upper edge is uniformly spaced from the lower edge such that the height of the upstanding wall 30 is substantially uniform. In other configurations, the height of the upstanding wall 30 may be varied about the perimeter of the base 20. Additionally, the upstanding wall is generally uniform about the perimeter of the base 20.

The lower opening 36, in the configuration shown, is defined proximate an intersection between the base 20 and the upstanding wall 30, and, preferably encompasses a portion of each of the base 20 and the upstanding wall 30. In other configurations, the lower opening may be defined in one of the base 20 and the upstanding wall 30.

The angled lower dispensing tube 14 is shown in FIG. 1 as extending from the lower opening 36 and surrounding the same so as to be in a fluid tight arrangement therewith. The angled lower dispensing tube extends from proximal end 40 to distal end 42. The angled lower dispensing tube has a generally circular cross-sectional configuration terminating in a spike at tip 48. The spike provides a relatively strong structure that is shaped so as to penetrate through the soil when directed and forced therethrough. In other configurations, the cross-sectional configuration may be other than circular, such as oval, elliptical, polygonal, as well as arbitrary. Additionally, it is contemplated that the particular shape may change along the length of the angled lower dispensing tube 14.

The angled lower dispensing tube 14 is defined by outer surface 44 and inner channel 46 which generally comprise the body thereof. The outer surface has an outer portion 50 and an inner portion 52. Generally, although not limited thereto, the outer portion 50 is the portion that would be visible when inserted into the planter were it not for the soil and which is generally outwardly and upwardly visible. The inner portion 52 therefore, generally, comprises the portion that is generally directed inwardly and downwardly. Of course, there may be some overlap and the precise boundary between the two portions may be loosely defined.

In the configuration shown, the angled lower dispensing tube is angled relative to the upper surface of the base preferably at an angle of approximately between 105° and 165° and more preferably between 120° and 150°, as these angles generally provide sufficient flow of fluids toward the distal end of the angled lower dispensing tube. Of course, the disclosure is not limited to any particular angle.

A plurality of openings 54 are disposed along the inner portion 52 (and, in some configurations may extend to the outer portion 50). These openings may comprise, for example, a plurality of spaced apart discrete openings (i.e., in the form of a circle, oval, polygon or the like, among others), whose major dimension is substantially less than the largest dimension of the inner channel 46. In other configurations, the openings may comprise elongated slot-like configurations (i.e., slots) whose major dimension is substantially larger than its minor dimension. In the configuration shown, a plurality of elongated slot-like configurations are disposed near the distal end in a spaced apart and generally parallel configuration and generally perpendicular to a central axis of the inner channel. Additionally, a plurality of spaced apart holes are positioned between the slots and the proximal end. In other configurations, such orientations, types and positions of the various openings may be varied without departing from the scope of the present disclosure.

The inner channel 46 is defined by a central axis 64 and includes base surface 60 as well as a plurality of longitudinal inward ribs, such as inward ribs 62. In the configuration shown, the base surface 60 comprises a generally uniform circular configuration (while, as set forth above, such configurations may be varied) between the proximal end 40 and the distal end 42.

The inward ribs 62 extend longitudinally between the proximal end and the distal end of the angled lower dispensing tube. In the configuration shown, a plurality of ribs are disposed about the base surface of the inner channel and extend inwardly toward the central region of the inner channel (or in the case of a uniform inner channel), toward the central axis 64 thereof. Collectively, the plurality of ribs define an inner capture region that is configured to retain a fertilizer spike (such as fertilizer spike 114 of FIG. 5), or the like so as to keep the same suspended within the inner channel and preferably away from the base surface. Preferably, the longitudinal inward ribs extend generally colinerly with the central axis of the inner channel.

In operation, either when planted, or after planting, the planter tube apparatus can be introduced. Specifically, the tip 48 is directed inwardly and downwardly toward the middle of the planter so the tip is positioned close to the root system of the plant.

As the tip extends into the soil 110, eventually the lower surface 24 of the base of the upper reservoir 12 abuts the upper rim 108 of the planter. So as to limit movement of the planter tube apparatus, the engaging tab in cooperation with the lower surface engages with the upstand of the planter proximate the upper rim thereof so as to limit further relative movement. In some configurations, other structures may be utilized, such as, for example, multiple engaging tabs, fasteners, such as hook and loop fasteners, snaps, slots and tabs and the like.

Once positioned, water, or other fluids, which may include various additional items (i.e., fertilizer, nutrients, oxygen, among other material), can be deposited into volume 27. Upon providing of the same to the volume 27, due to gravity, the fluids progress into the angled lower dispensing tube 14 and proceed toward the distal end thereof. Of course, due to the openings 54 along the outer surface, some of the fluids escape into the soil. Due to the relatively open inner channel, the fluid will tend to accumulate within the angled lower dispensing tube and therefore extend out of a plurality of the different openings. It will be understood that the upper reservoir may be used as a measuring cup so that a proper amount of fluids is provided and so that they can be measured. Additionally, the rate of absorption can be measured in some configurations. It will further be understood that the upper reservoir may be graduated with markings or other structures so that a user can determine the amount of fluid that is captured within the planter tube apparatus.

From time to time, a user may wish to utilize a fertilizer which is generally in a spike form. Typically, a fertilizer spike comprises an elongated member having a generally uniform circular cross-section. Such a fertilizer spike can be inserted into the inner channel. Due to the configuration of the spike and the configuration of the longitudinal inner ribs, the fertilizer is captured by the longitudinal inward ribs and spaced apart from the base surface of the inner channel of the angled lower dispensing tube. As such, fluid can contact fertilizer spike generally around its periphery and promote substantially uniform decomposition and degradation of the spike, and therefore substantially uniform delivery of the fertilizer through the openings to the soil and to the plant.

It will be understood that in various configurations, the angled lower dispensing tube may be tapered, or a funnel shape. This may allow for improved packaging and shipping of the planter tube apparatus, as multiple units may be stacked onto each other.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A planter tube apparatus comprising:
an upper reservoir comprising a base and an upstanding wall, defining a volume, with a lower opening defined in at least one of the base and the upstanding wall in fluid communication with the volume; and
an angled lower dispensing tube extending from the upper reservoir, the angled lower dispensing tube being angled relative to the base of the upper reservoir, the angled lower dispensing tube having an outer surface and an inner channel, extending between a proximal end and a distal end, with a plurality of openings being positioned therebetween and extending through the outer surface and into the inner channel.

2. The planter tube apparatus of claim 1 wherein the base has an upper surface and a lower surface, with the angled lower dispensing tube being angled relative to a plane defined by the upper surface of the base at an angle of approximately between 105° and 165°.

3. The planter tube apparatus of claim 2 wherein the angle is between 120° and 150°.

4. The planter tube apparatus of claim 1 wherein the base has an upper surface and a lower surface, and further includes an engaging tab extending from the lower surface, structurally configured to engage a planter about an upper rim therof.

5. The planter tube apparatus of claim 4 wherein the engaging tab extends generally perpendicularly from the lower surface of the base of the upper reservoir.

6. The planter tube apparatus of claim 1 wherein the angled lower dispensing tube further includes a tip defined at the distal end thereof which aids in the penetration of the angled lower dispensing tube into a soil.

7. The planter tube apparatus of claim 1 wherein the openings of the angled lower dispensing tube include a plurality of at least one of holes and slots, with the slots being substantially perpendicular to a central axis of the inner channel.

8. The planter tube apparatus of claim 7 wherein the angled lower dispensing tube further includes an outer portion and an inner portion, with the openings being disposed on the inner portion between the proximal and distal end of the angled lower dispensing tube.

9. The planter tube apparatus of claim 8 wherein a plurality of slots in a substantially parallel configuration is disposed proximate the distal end.

10. The planter tube apparatus of claim 9 wherein a plurality of holes is disposed between the plurality of slots and the proximal end of the angled lower dispensing tube.

11. The planter tube apparatus of claim 1 wherein the upstanding wall is substantially perpendicular to an upper surface of the base of the upper reservoir.

12. The planter tube apparatus of claim 11 wherein the upstanding wall has a cross-sectional configuration of a flower.

13. The planter tube apparatus of claim 1 wherein the inner channel has a plurality of longitudinal ribs that extend inwardly from a base surface of the inner channel toward a central axis thereof, with the plurality of longitudinal ribs defining a fertilizer spike receiving region.

14. The planter tube apparatus of claim 13 wherein the longitudinal inward ribs extend generally colinerly with the central axis of the inner channel.

15. The planter tube apparatus of claim 14 wherein the upper reservoir and the angled lower dispensing tube are integrally molded.

16. The planter tube apparatus of claim 1 wherein the lower opening of the upper reservoir is defined in a portion of each of the base and the upstanding wall.

17. A combination planter and planter tube apparatus comprising:
the planter tube apparatus according to claim 1; and
a planter including:
a base with an upstand extending from the base, the upstand terminating in an upper rim, with the base and the upstand defining a central cavity structurally configured to receive a soil into which a plant may be planted.

18. A method of using a planter tube apparatus comprising the steps of:
providing a planter having a base and an upstand defining a central cavity;
providing a planter tube apparatus including an upper reservoir with a base and an upstanding wall, cooperatively defining a volume with a lower opening in fluid communication with the volume, and, an angled lower dispensing tube extending from the upper reservoir, the angled lower dispensing tube having an outer surface and an inner channel in fluid communication with the lower opening of the upper reservoir, with a plurality of openings extending through the outer surface and into the inner channel;
inserting the planter tube apparatus into the central cavity of the planter;
providing soil into the central cavity of the planter, wherein at least a portion of the angled lower dispensing tube is in the soil;
providing a plant, with at least a portion of the plant being within the soil; and
providing a fluid into the upper reservoir, so that the fluid can proceed through the angled lower dispending tube and through the openings thereof into the soil.

19. The method of claim 18 wherein the inner channel includes a plurality of longitudinal inward ribs, the method further comprising the step of: inserting a fertilizer spike into the inner channel of the angled lower dispensing tube, wherein the fertilizer spike is captured by the longitudinal inward ribs.
